(19) United States
(12) Patent Application Publication
(10) Pub. No.: US 2026/0264264 A1
(43) Pub. Date: Sep. 10, 2026

(54) FINGER MODULE OF ROBOT AND BIONIC HAND OF ROBOT

(71) Applicant: Beijing Youzhuju Network Technology Co., Ltd., Beijing (CN)

(72) Inventors: Jiajun ZHANG, Beijing (CN); Zeyu Ren, Beijing (CN); Zhongren Cui, Beijing (CN); Ruoshi Wen, Beijing (CN); Guangzeng Chen, Beijing (CN); Jiawen Tian, Beijing (CN)

(21) Appl. No.: 19/409,680

(22) Filed: Dec. 4, 2025

(30) Foreign Application Priority Data
Mar. 5, 2025 (CN) 202510256851.0

(51) Int. Cl. B25J 15/00

(52) U.S. Cl. CPC B25J 15/0009

(57) ABSTRACT

Embodiments of the disclosure provide a finger module of a robot, including a base rotatably coupled to a palm module of the robot; a proximal phalange power transmission assembly and a middle phalange power transmission assembly at least partially fixedly coupled to the base, and respectively including a proximal phalange power output portion and a middle phalange power output portion capable of performing a telescopic motion in an axial direction of the base; a proximal phalange link assembly and a middle phalange link assembly, the proximal phalange link assembly being movably coupled between the proximal phalange power output portion and the base, the middle phalange link assembly being movably coupled between the middle phalange power output portion and a fingertip link and being movably coupled to the proximal phalange link assembly; and the fingertip link movably coupled to a first end of the middle phalange link assembly.

### CROSS-REFERENCE

This application claims priority to Chinese Patent Application No. 202510256851.0, filed Mar.. 05, 2025, entitled “FINGER MODULE OF ROBOT AND BIONIC HAND OF ROBOT”, the disclosure of which is incorporated herein by reference in its entirety.

### FIELD

Example embodiments of the present disclosure generally relate to the field of robots, and in particular, to a robot finger module and a bionic hand of a robot.

### BACKGROUND

A dexterous hand of a robot is a robot end effector that can mimic a human hand. The dexterous hand has been rapidly developed in recent years due to its advantages of multiple degrees of freedom, high flexibility, good bionic effects, and the like, and is often integrated at the end of a mechanical arm to perform tasks such as grasping or operating tools.

The dexterous hand of a robot is generally a combination of multiple finger modules. In terms of a transmission structure, a finger module of a conventional dexterous hand generally has two solutions: one is to use a form of a coreless motor and a rope drive, and the other is to use a linear driver and a link transmission.

### SUMMARY

In a first aspect of the present disclosure, a finger module of a robot is provided. The finger module includes: a base rotatably coupled to a palm module of the robot; a proximal phalange power transmission assembly and a middle phalange power transmission assembly at least partially fixedly coupled to the base and respectively including a proximal phalange power output portion and a middle phalange power output portion capable of performing a telescopic motion in an axial direction of the base; a proximal phalange link assembly and a middle phalange link assembly, the proximal phalange link assembly being movably coupled between the proximal phalange power output portion and the base, the middle phalange link assembly being movably coupled between the middle phalange power output portion and a fingertip link, and being movably coupled to the proximal phalange link assembly; and the fingertip link movably coupled to a first end of the middle phalange link assembly to be adapted to contact or grasp an object; the proximal phalange link assembly and the middle phalange link assembly have a common first pin about which the proximal phalange link assembly and the middle phalange link assembly are rotatable, such that shapes of the proximal phalange link assembly and the middle phalange link assembly and a grasping angle of the corresponding fingertip link are changeable under driving of the proximal phalange power output portion and the middle phalange power output portion that perform the telescopic motion.

In some embodiments, the finger module further includes: a motor fixing base fixedly coupled to a side of the base away from the proximal phalange link assembly; a proximal phalange link fixing base fixedly coupled to a side of the base close to the proximal phalange link assembly for a first end of the proximal phalange link assembly to be movably coupled.

In some embodiments, the proximal phalange power transmission assembly includes a proximal phalange drive motor fixedly coupled to the motor fixing base and including a first output shaft; a middle phalange power transmission assembly includes a middle phalange drive motor fixedly coupled to the motor fixing base and including a second output shaft, where an axis of the second output shaft is parallel to an axis of the first output shaft.

In some embodiments, the proximal phalange power output portion includes a first ball screw including: a first bearing having an outer race fixedly coupled to the base via a bearing pressure plate; a first screw fixedly coupled to an inner race of the first bearing and coupled to the first output shaft via a first coupling in the axial direction of the first output shaft, to rotate about an axis of the first screw and a first nut movably coupled to the first screw.

In some embodiments, the middle phalange power output portion includes a second ball screw including a second bearing having an outer race fixedly coupled to the base via the bearing pressure plate; a second screw fixedly coupled to an inner race of the second bearing and coupled to the second output shaft via a second coupling in the axial direction of the second output shaft, to rotate about an axis of the second screw; and a second nut movably coupled to the second screw.

In some embodiments, the proximal phalange link assembly includes: a first proximal phalange connecting block fixedly coupled to the first nut; a second proximal phalange link having a first end movably coupled to the first proximal phalange connecting block; a third proximal phalange link having a first end movably coupled to a second end of the second proximal phalange link via the first pin, a second end of the third proximal phalange link being movably coupled to the proximal phalange link fixing base, and a third end and a fourth end of the third proximal phalange link being movably coupled to the middle phalange link assembly; the first end and the second end being arranged on a side of the third proximal phalange link close to the proximal phalange link fixing base, and the third end and the fourth end being arranged on a side of the third proximal phalange link close to the fingertip link.

In some embodiments, the middle phalange link assembly includes: a first middle phalange link having a first end movably coupled to the second nut; a second middle phalange link having a first end movably coupled to a second end of the first middle phalange link; a third middle phalange link having a first end movably coupled to the second proximal phalange link via the first pin and a second end movably coupled to a second end of the second middle phalange link via a second pin, the third middle phalange link having a triangular cross section in a plane perpendicular to an axis of the first pin, and the first end, the second end, and a third end of the third middle phalange link being three vertices of the triangle; a fourth middle phalange link having a first end movably coupled to the third end of the third middle phalange link via a third pin; a fifth middle phalange link having a first end movably coupled to a second end of the fourth middle phalange link, a second end of the fifth middle phalange link being movably coupled to the fingertip link, and a third end of the fifth middle phalange link being movably coupled to the third end of the third proximal phalange link; and a sixth middle phalange link having a first end movably coupled to the fourth end of the third proximal phalange link and a second end movably coupled to the fingertip link.

In some embodiments, the first proximal phalange connecting block includes: a first body portion including a pair of through holes and a fixing hole located between the pair of through holes, where the first nut is fixedly coupled to the fixing hole; and a first connecting portion arranged to extend from the first body portion in an axial direction of the first screw and having a pair of first connecting holes.

In some embodiments, the finger module further includes a pair of guide posts, each guide post of the pair of guide posts passing through a corresponding through hole of the pair of through holes and being symmetrically arranged on two sides of the first screw and fixedly coupled to the base, so as to be adapted to allow the first proximal phalange connecting block to slide along the guide post.

In some embodiments, the second proximal phalange link is generally Y-shaped, and includes: a link coupled between a pair of first connecting holes of the first connecting portion of the first proximal phalange connecting block; and a pair of bifurcated portions arranged at one end of the link and extending in an extending direction of the link, the pair of bifurcated portions having a pair of second connecting holes in a direction perpendicular to the link.

In some embodiments, the third proximal phalange link includes: a pair of connecting rods, a U-shaped connecting portion arranged on the pair of connecting rods and extending in a direction perpendicular to the connecting rods; a pair of first extending portions arranged at an end of the pair of connecting rods close to the proximal phalange link fixing base, and movably coupled to the proximal phalange link fixing base; a pair of lugs arranged on a side of the pair of connecting rods facing the second proximal phalange link and coupled between the pair of second connecting holes of the pair of bifurcated portions via the first pin; a pair of second extending portions arranged at an end of the pair of connecting rods away from the proximal phalange link fixing base and movably coupled to the fifth middle phalange link and movably coupled to the sixth middle phalange link.

In some embodiments, the third middle phalange link includes: a connecting sleeve movably coupled between the pair of lugs of the third proximal phalange link via the first pin; a pair of connecting portions extending from the connecting sleeve in a direction perpendicular to an axis of the connecting sleeve, and having a triangular shape, one end of a base end of each connecting portion being coupled to the first end of the fourth middle phalange link, and the other end of the base end of each connecting portion being coupled to a second end of the second middle phalange link opposite to the first end.

In some embodiments, the finger module further includes a guide rail including: a slide rail fixedly coupled to the proximal phalange link fixing base and a slider fixedly coupled to the second nut and adapted to perform linear motion along the slide rail.

In some embodiments, the finger module further includes an anti-slip rubber sleeve fixedly coupled to the fingertip link.

In a second aspect of the present disclosure, a bionic hand for a robot is provided. The bionic hand includes: a palm module movably coupled to a forearm mechanism of the robot via a wrist joint; and the finger module according to the first aspect coupled to the palm module.

It should be understood that the content described in this Summary is not intended to limit the key or essential features of embodiments of the present disclosure, and is not intended to limit the scope of the present disclosure. Other features of the present disclosure will be readily envisaged from the following description.

### BRIEF DESCRIPTION OF THE DRAWINGS

The above and other features, advantages, and aspects of embodiments of the present disclosure will become more apparent in combination with the drawings and with reference to the following detailed description.

In the drawings, the same or similar reference numbers refer to the same or similar elements.

FIG. 1 is a cross-sectional view of a finger module according to embodiments of the present disclosure;

FIG. 2 is a schematic perspective view of a finger module according to embodiments of the present disclosure;

FIG. 3 is a schematic diagram of a fingertip joint and an intermediate joint of a finger module being bent according to embodiments of the present disclosure;

FIG. 4 is a schematic diagram of a proximal palm joint of a finger module being bent according to embodiments of the present disclosure; and

FIG. 5 is a schematic diagram of three joints, namely, a fingertip joint, an intermediate joint, and a proximal palm joint, of a finger module being bent according to embodiments of the present disclosure.

### DETAILED DESCRIPTION OF EMBODIMENTS

Embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the titles of any sections/subsections provided herein are not restrictive. Various embodiments are described throughout this article, and any type of embodiment may be included under any section/subsection. In addition, embodiments described in any section/subsection may be combined with any other embodiments described in the same section/subsection and/or different sections/subsections in any manner.

In the description of embodiments of the present disclosure, the term "include/comprise" and similar terms should be understood as open-ended inclusions, that is, "include/comprise but not limited to". The term "based on" should be understood as "at least partially based on". The term "an embodiment" or "the embodiment" should be understood as "at least one embodiment". The term "some embodiments" should be understood as "at least some embodiments". Other explicit and implicit definitions may also be included below. The terms "first", "second", etc. may refer to different or same objects. Other explicit and implicit definitions may also be included below.

As mentioned above, a dexterous hand of a robot is generally a combination of multiple finger modules. In terms of a transmission structure, a finger module of a conventional dexterous hand generally has two solutions: one is to use a form of a coreless motor and a rope drive, but most have the problems of low reliability, low transmission precision, complex structure, high failure rate, and difficulty in maintenance. The other is to use a linear driver and a link transmission. In this solution, considering the complexity of a link structure, the number of drivers, and the layout, a simplified process of reducing the number of rotating joints of a single finger is usually adopted, that is, the fingertip joint and the intermediate joint of the finger are combined into one rotating joint, and together with the rotating joint at the proximal palm end, three joints of the single finger in the bending and stretching direction are simplified into two joints. However, while simplifying the transmission structure, this processing form reduces the bionics of the finger, thereby affecting the grasping posture that the finger may provide and reducing the dexterity of the finger.

To solve or at least partially solve the above-mentioned or other potential problems of the finger module of the dexterous hand in the conventional solution, embodiments of the present disclosure provide a robot finger module and a hand structure of a robot. According to the solution of embodiments of the present disclosure, the bending and stretching movements of the three joints of the finger are driven by two linear drivers, thereby simplifying the transmission structure of the finger module. The link transmission scheme is adopted to ensure the structural reliability and reduce the weight of the finger module. Further, a rotation of the three finger joints is controlled by a transmission form of driving a screw with two motors, to realize a motion decoupling between the intermediate joint and the joint at the proximal palm end of the finger, thereby improving the motion flexibility and bionics of the finger.

The robot according to embodiments of the present disclosure may be any suitable robot, for example, including but not limited to a humanoid robot, a crawling robot, an industrial robot, a service robot, a fully automatic robot, a semi-automatic robot, a remote control robot, a mechanical arm robot, and the like.

For example, a humanoid robot is used as an example to illustrate an example structure of the robot according to embodiments of the present disclosure. The humanoid robot may include the following main components: a head, a torso, arms, hands (also referred to as finger modules), legs, and feet. These components may be connected by the joint device according to embodiments of the present disclosure to mimic natural postures and movements of a human. Their connection design not only needs to ensure the flexibility between the components, but also needs to have certain stability and strength to cope with complex movements and loads. The concept according to the present disclosure will be mainly described below by using the finger module of the robot as an example. It should be understood that the cases of other types of robots are similar, and will not be described separately below.

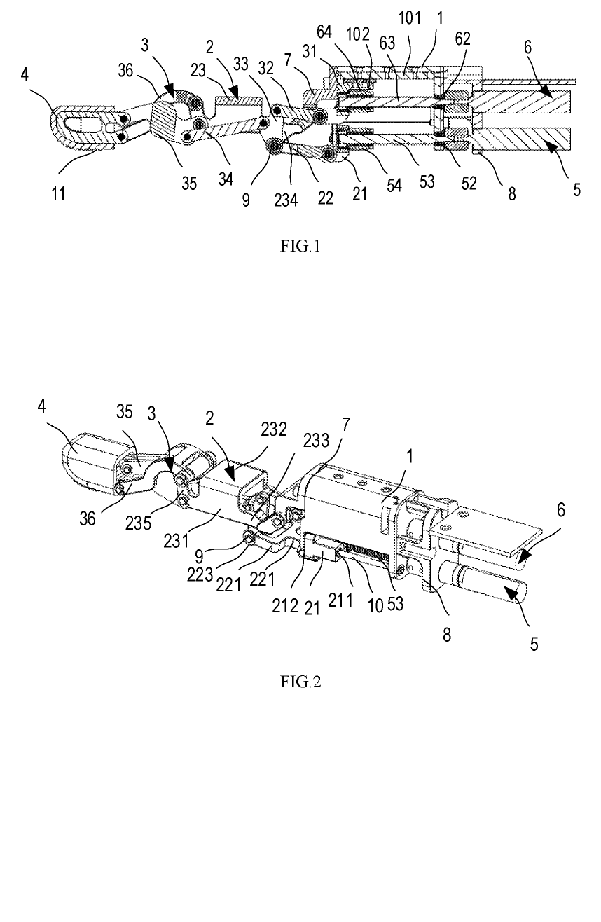

An example structure of the finger module will be described below with reference to FIG. 1 and FIG. 2. The finger module according to embodiments of the present disclosure generally includes a base 1, a proximal phalange power transmission assembly 5, a middle phalange power transmission assembly 6, a proximal phalange link assembly 2, a middle phalange link assembly 3, and a fingertip link 4.

The base 1 is rotatably coupled to a palm module of the robot. The proximal phalange power transmission assembly 5 and the middle phalange power transmission assembly 6 are at least partially fixedly coupled to the base 1, and respectively include a proximal phalange power output portion and a middle phalange power output portion that are capable of performing a telescopic motion in an axial direction of the base 1. The proximal phalange link assembly 2 is movably coupled between the proximal phalange power output portion and the base 1, and the middle phalange link assembly 3 is movably coupled between the middle phalange power output portion and the fingertip link 4, and is movably coupled to the proximal phalange link assembly 2.

The proximal phalange link assembly 2 and the middle phalange link assembly 3 respectively include a plurality of links, and each link may rotate about a respective pin, so as to change motion states of the proximal phalange link assembly 2 and the middle phalange link assembly 3. A specific implementation structure will be further described below.

The fingertip link 4 is movably coupled to a first end of the middle phalange link assembly 3, and is adapted to contact or grasp an object. The proximal phalange link assembly 2 and the middle phalange link assembly 3 have a common first pin 9 about which the proximal phalange link assembly 2 and the middle phalange link assembly 3 may rotate, such that shapes of the proximal phalange link assembly 2 and the middle phalange link assembly 3 and a grasping angle of the corresponding fingertip link 4 may be changed under the driving of the proximal phalange power output portion and the middle phalange power output portion that perform the telescopic motion. That is, the proximal phalange link assembly 2 and the middle phalange link assembly 3 are hinged by the first pin 9, and the proximal phalange link assembly 2 may rotate about the first pin 9 relative to the middle phalange link assembly under the driving of the power output portion. In addition, the links inside the proximal phalange link assembly 2 are also hinged by the first pin 9, and the specific implementation structure will be further described below. In this way, with two power output portions, bending movements of the three joints, namely, the fingertip joint, the intermediate joint, and the proximal palm joint, are realized, thereby simplifying the transmission structure of the finger module, and improving the motion flexibility and bionics of the finger.

In some embodiments, the finger module further includes a motor fixing base 8 and a proximal phalange link fixing base 7. The motor fixing base 8 is fixedly coupled to a side of the base 1 away from the proximal phalange link assembly 2. The proximal phalange link fixing base 7 is fixedly coupled to a side of the base 1 close to the proximal phalange link assembly 2, for a first end of the proximal phalange link assembly 2 to be movably coupled. In this way, the motor fixing base and the proximal phalange link fixing base are arranged on two sides of the base, thereby simplifying the module mounting structure, to realize driving the proximal phalange link assembly and the middle phalange link assembly by the motor in the axial direction of the base.

In some embodiments, the proximal phalange power transmission assembly 5 includes a proximal phalange drive motor 51 fixedly coupled to the motor fixing base 8, and the proximal phalange drive motor 51 includes a first output shaft. The middle phalange power transmission assembly 6 includes a middle phalange drive motor 61 fixedly coupled to the motor fixing base 8, and the middle phalange drive motor 61 includes a second output shaft. An axis of the second output shaft is parallel to an axis of the first output shaft. That is, the first output shaft of the proximal phalange drive motor and the second output shaft of the middle phalange drive motor are parallel. In this way, by fixing two motors arranged in parallel on the motor fixing base, the overall occupied space may be reduced, and the entire finger assembly may be made more compact. Meanwhile, the motors arranged in parallel may realize a synchronous movement through a precise control algorithm, to ensure the movement consistency between the proximal phalange link assembly and the middle phalange link assembly.

In some embodiments, the proximal phalange power output portion includes a first ball screw, and the first ball screw includes a first bearing 52, a first screw 53, and a first nut 54. An outer race of the first bearing 52 is fixedly coupled to the base 1 via a bearing pressure plate, the first screw 53 is fixedly coupled to an inner race of the first bearing 52, and is coupled to the first output shaft via a first coupling in the axial direction of the first output shaft, to rotate about an axis of the first screw, and the first nut 54 is movably coupled to the first screw 53. Further, the first nut 54 is fixedly coupled to the proximal phalange link assembly 2, and the proximal phalange drive motor 51 drives the first screw 53 to rotate, to drive the first nut 54 to reciprocate, thereby realizing a movement of the proximal phalange link assembly 2.

In some embodiments, the middle phalange power output portion includes a second ball screw, and the second ball screw includes a second bearing 62, a second screw 63, and a second nut 64. An outer race of the second bearing 62 is fixedly coupled to the base 1 via a bearing pressure plate, the second screw 63 is fixedly coupled to an inner race of the second bearing 62, and is coupled to the second output shaft via a second coupling in the axial direction of the second output shaft, to rotate about an axis of the second screw, and the second nut 64 is movably coupled to the second screw 63. Further, the second nut 64 is fixedly coupled to the middle phalange link assembly 3, and the middle phalange drive motor 61 drives the second screw 63 to rotate, to drive the second nut 64 to reciprocate, thereby realizing a movement of the middle phalange link assembly 3. In this way, through the transmission mode of driving the ball screw by the motor, the transmission friction may be reduced, and the transmission efficiency and transmission precision may be improved. Further, the power output assembly may include a linear drive motor.

In some embodiments, the proximal phalange link assembly 2 includes a first proximal phalange connecting block 21, a second proximal phalange link 22, and a third proximal phalange link 23. The first proximal phalange connecting block 21 is fixedly coupled to the first nut 54, and a first end of the second proximal phalange link 22 is movably coupled to the first proximal phalange connecting block 21.

A first end of the third proximal phalange link 23 is movably coupled to a second end of the second proximal phalange link 22 via the first pin 9, a second end of the third proximal phalange link 23 is movably coupled to the proximal phalange link fixing base 7, and a third end and a fourth end of the third proximal phalange link 23 are movably coupled to the middle phalange link assembly. The first end and the second end are arranged on a side of the third proximal phalange link 23 close to the proximal phalange link fixing base 7, and the third end and the fourth end are arranged on a side of the third proximal phalange link 23 close to the fingertip link 4.

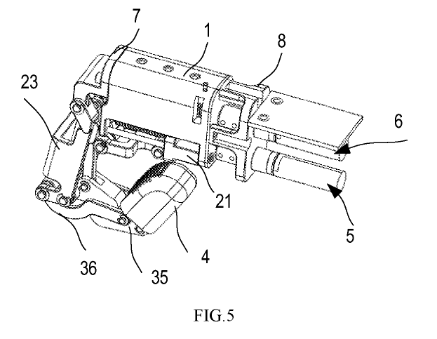

As shown in FIG. 4, the first proximal phalange connecting block 21 and the second proximal phalange link 22 drive the third proximal phalange link 23 to rotate counterclockwise about the proximal phalange link fixing base 7, to realize an adduction and bending movement of the proximal palm joint of the finger. The first proximal phalange connecting block 21 and the second proximal phalange link 22 drive the third proximal phalange link 23 to rotate clockwise about the proximal phalange link fixing base 7, to realize an abduction movement of the interphalangeal joint. In this way, the adduction and abduction of the finger are realized through the rotation of the three links, which may highly mimic the movement function of the human finger, provide a large range of motion, enable the finger to adapt to objects of different shapes and sizes, and increase the flexibility and adaptability of the manipulator. The specific implementation structure of the third proximal phalange link 23 will be further described below.

In some embodiments, the middle phalange link assembly 3 includes a first middle phalange link 31, a second middle phalange link 32, a third middle phalange link 33, a fourth middle phalange link 34, a fifth middle phalange link 35, and a sixth middle phalange link 36.

A first end of the first middle phalange link 31 is movably coupled to the second nut 64, and a first end of the second middle phalange link 32 is movably coupled to a second end of the first middle phalange link 31.

A first end of the third middle phalange link 33 is movably coupled to the second proximal phalange link 22 via the first pin 9, a second end of the third middle phalange link 33 is movably coupled to a second end of the second middle phalange link 32 via a second pin, the third middle phalange link 33 has a substantially triangular cross section in a plane perpendicular to an axis of the first pin 9, and the first end, the second end, and a third end of the third middle phalange link 33 are three vertices of the triangle. The specific implementation structure of the third middle phalange link 33 will be further described below.

A first end of the fourth middle phalange link 34 is movably coupled to the third end of the third middle phalange link 33 via a third pin. A first end of the fifth middle phalange link 35 is movably coupled to a second end of the fourth middle phalange link 34, a second end of the fifth middle phalange link 35 is movably coupled to the fingertip link 4, and a third end of the fifth middle phalange link 35 is movably coupled to the third end of the third proximal phalange link 23. A first end of the sixth middle phalange link 36 is movably coupled to the fourth end of the third proximal phalange link 23, and a second end of the sixth middle phalange link 36 is movably coupled to the fingertip link 4.

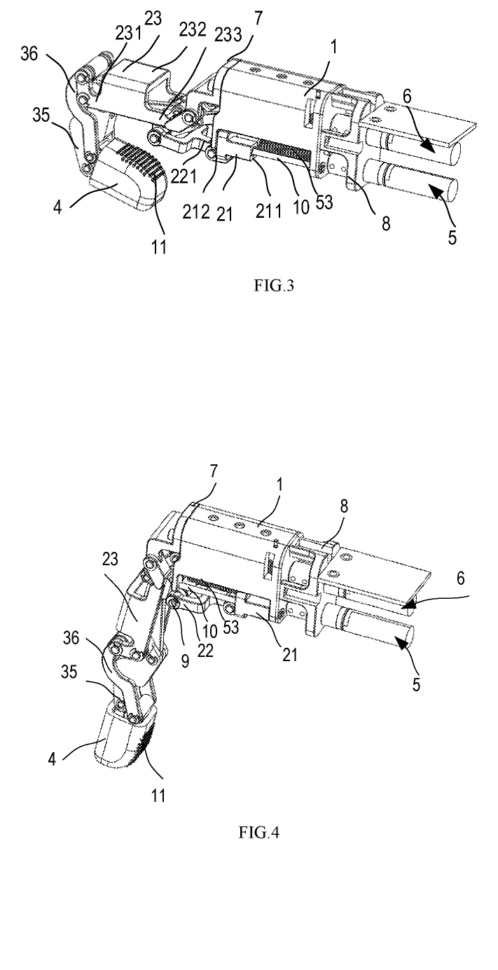

As shown in FIG. 3, when the third proximal phalange link 23 is fixed, and the second screw 63 is driven to rotate by the forward rotation of the middle phalange drive motor 61, the second nut 64 performs linear motion, and the fifth middle phalange link 35 is driven by the first middle phalange link 31, the second middle phalange link 32, the third middle phalange link 33, and the fourth middle phalange link 34 to rotate counterclockwise, thereby realizing an adduction and bending movement of the intermediate joint of the finger. The fifth middle phalange link 35 is driven by the first middle phalange link 31, the second middle phalange link 32, the third middle phalange link 33, and the fourth middle phalange link 34 to rotate clockwise, to realize an abduction movement of the intermediate joint of the finger.

As shown in FIG. 3 and FIG. 5, the third proximal phalange link 23, the fifth middle phalange link 35, the sixth middle phalange link 36, and the fingertip link 4 constitute an anti-quadrilateral mechanism, and the movement characteristics of the anti-quadrilateral are utilized, to realize a linkage bending movement of the intermediate joint and the fingertip joint of the finger, and the movement direction is consistent with the movement direction of the intermediate joint.

In some embodiments, the first proximal phalange connecting block 21 includes a first body portion and a first connecting portion. The first body portion includes a pair of through holes 211 and a fixing hole located between the pair of through holes 211, and the first nut 54 is fixedly coupled to the fixing hole. The first connecting portion is arranged to extend from the first body portion in an axial direction of the first screw 53, and has a pair of first connecting holes. In this way, the proximal phalange drive motor 51 drives the first screw 53 to rotate, to drive the first nut 54 and the first proximal phalange connecting block 21 coupled to the first nut 54 to reciprocate.

In some embodiments, as shown in FIG. 2, the finger module further includes a pair of guide posts 10 symmetrically arranged on two sides of the first screw 53 and fixedly coupled to the base 1. Each guide post 10 passes through a corresponding through hole 211 of the pair of through holes 211 of the first proximal phalange connecting block 21. The proximal phalange drive motor 51 drives the first screw 53 to rotate, to drive the first proximal phalange connecting block 21 on the first nut 54 to perform reciprocating linear motion along the guide post 10. In this way, the guide post guides the motion trail of the first nut and the first proximal phalange connecting block, thereby ensuring no offset or inclination occurs in the reciprocating linear motion, and significantly reducing the friction and wear during the motion process.

In some embodiments, the second proximal phalange link 22 is generally Y-shaped, and includes a link 221 and a pair of bifurcated portions 222. The link 221 is coupled between a pair of first connecting holes 212 of the first connecting portion of the first proximal phalange connecting block 21. The pair of bifurcated portions 222 are arranged at one end of the link 221 and extend in an extending direction of the link 221, and the pair of bifurcated portions have a pair of second connecting holes 223 in a direction perpendicular to the link 221. One end of the third proximal phalange link 23 is coupled between the pair of bifurcated portions 222 via the first pin 9. In this way, the bifurcated portions 222 are symmetrically coupled to the third proximal phalange link 23, and the stability of link connection is further improved.

In some embodiments, the third proximal phalange link 23 includes a pair of connecting rods 231, a U-shaped connecting portion 232, a pair of first extending portions 233, a pair of lugs 234, and a pair of second extending portions 235.

The third proximal phalange link 23 has a first end, a second end, a third end, and a fourth end. The first end and the second end are arranged on a side of the third proximal phalange link 23 close to the proximal phalange link fixing base 7, and the third end and the fourth end are arranged on a side of the third proximal phalange link 23 close to the fingertip link 4.

The U-shaped connecting portion 232 is arranged on the pair of connecting rods 231 and extends in a direction perpendicular to the connecting rods 231. The pair of first extending portions 233 are arranged at an end of the pair of connecting rods 231 close to the proximal phalange link fixing base 7, and are movably coupled to the proximal phalange link fixing base 7. Further, the pair of first extending portions 233 include the first end of the third proximal phalange link 23, and the first end is movably coupled to the proximal phalange link fixing base 7. The first extending portion 233 is coupled to the proximal phalange link fixing base 7, such that the first proximal phalange link 23 may rotate relative to the proximal phalange link fixing base 7.

The pair of lugs 234 are arranged on a side of the pair of connecting rods 231 facing the second proximal phalange link 22, and are coupled between the pair of second connecting holes 223 of the pair of bifurcated portions 222 via the first pin 9. Further, the pair of lugs 234 include the second end of the third proximal phalange link 23, and the second end is coupled between the pair of second connecting holes 223 of the pair of bifurcated portions 222 via the first pin 9. That is, the pair of lugs 234 are coupled between the bifurcated portions 222 via the first pin 9. In this way, the second proximal phalange link 22 is movably coupled to the pair of lugs of the third proximal phalange link 23 via the pair of bifurcated portions, such that the second proximal phalange link 22 rotates relative to the third proximal phalange link 23.

The pair of second extending portions 235 are arranged at an end of the pair of connecting rods 231 away from the proximal phalange link fixing base 7, and are movably coupled to the fifth middle phalange link 35 and movably coupled to the sixth middle phalange link 36. Further, the pair of second extending portions 235 as a whole extend in a direction perpendicular to the pair of connecting rods 231, and include the third end of the third proximal phalange link 23, which is movably coupled to the fifth middle phalange link 35. The pair of second extending portions 235 include the fourth end of the third proximal phalange link 23, which is movably coupled to the sixth middle phalange link 36.

The third proximal phalange link is arranged with a plurality of ends, to realize movable hinge connection with the phalange link fixing base 7, the second proximal phalange link 22, the fifth middle phalange link 35, and the sixth middle phalange link 36, thereby simplifying the structure of the finger module, and improving the motion flexibility of the finger module.

In some embodiments, the third middle phalange link 33 includes a connecting sleeve and a pair of connecting portions. The connecting sleeve is movably coupled between the pair of lugs 234 of the third proximal phalange link 23 via the first pin 9. The connecting sleeve is coupled between the pair of lugs 234 via the first pin 9, and the pair of lugs 234 are coupled between the pair of bifurcated portions via the first pin. That is, the connecting sleeve, the pair of lugs 234, and the pair of bifurcated portions are simultaneously coupled to the first pin 9, such that the third middle phalange link 33, the third proximal phalange link 23, and the second proximal phalange link 22 are simultaneously coupled to the first pin 9. The proximal phalange link assembly and the middle phalange link assembly have a common first pin 9 about which the proximal phalange link assembly and the middle phalange link assembly may rotate, such that the shapes of the proximal phalange link assembly and the middle phalange link assembly and the grasping angle of the corresponding fingertip link may be changed under the driving of the proximal phalange power output portion and the middle phalange power output portion that perform the telescopic motion.

The pair of connecting portions extend from the connecting sleeve in a direction perpendicular to an axis of the connecting sleeve, and are generally triangular. One end of a base end of the connecting portion is coupled to the first end of the fourth middle phalange link 34, and the other end of the base end of the connecting portion is coupled to the second end of the second middle phalange link 32 opposite to the first end. Through the pair of connecting portions, a movable coupling connection among the second middle phalange link 32, the third middle phalange link 33, and the fourth middle phalange link 34 is realized. By arranging the triangular structure link, the link connection structure is simplified, the finger movement flexibility is improved, and at the same time, the force transmission is more uniform, and the local stress concentration is reduced.

In some embodiments, the finger module further includes a guide rail 10, and the guide rail 10 includes a slide rail 101 and a slider 102. The slide rail 101 is fixedly coupled to the proximal phalange link fixing base 7, and the slider 102 is fixedly coupled to the second nut 64, and is capable of performing linear motion along the slide rail 101. The slider linearly slides along the slide rail, to reduce the sliding friction, and at the same time, improve the ability of the second screw to bear lateral force.

In some embodiments, the finger module further includes an anti-slip rubber sleeve 11 fixedly coupled to the fingertip link 4, and the anti-slip rubber sleeve 11 is arranged to improve the anti-slip performance of the fingertip.

The implementations of the present disclosure have been described above, and the above description is illustrative, non-exhaustive, and not limited to the disclosed implementations. Many modifications and variations will be apparent to those of ordinary skill in the art without departing from the scope and spirit of the described implementations. The terms used herein are chosen to best explain the principles of the implementations, the practical application or improvement to the technology in the market, or to enable other persons of ordinary skill in the art to understand the implementations disclosed herein.

1. A finger module of a robot, comprising:
a base rotatably coupled to a palm module of the robot;
a proximal phalange power transmission assembly and a middle phalange power transmission assembly at least partially fixedly coupled to the base and respectively comprising a proximal phalange power output portion and a middle phalange power output portion capable of performing a telescopic motion in an axial direction of the base;
a proximal phalange link assembly and a middle phalange link assembly, the proximal phalange link assembly being movably coupled between the proximal phalange power output portion and the base, the middle phalange link assembly being movably coupled between the middle phalange power output portion and a fingertip link and being movably coupled to the proximal phalange link assembly; and
the fingertip link movably coupled to a first end of the middle phalange link assembly to be adapted to contact or grasp an object,
wherein the proximal phalange link assembly and the middle phalange link assembly have a common first pin about which the proximal phalange link assembly and the middle phalange link assembly are rotatable, such that shapes of the proximal phalange link assembly and the middle phalange link assembly and a grasping angle of the corresponding fingertip link are changeable under driving of the proximal phalange power output portion and the middle phalange power output portion that perform the telescopic motion.

2. The finger module of claim 1, further comprising:
a motor fixing base fixedly coupled to a side of the base away from the proximal phalange link assembly; and
a proximal phalange link fixing base fixedly coupled to a side of the base close to the proximal phalange link assembly for a first end of the proximal phalange link assembly to be movably coupled.

3. The finger module of claim 2, wherein
the proximal phalange power transmission assembly comprises: a proximal phalange drive motor fixedly coupled to the motor fixing base and comprising a first output shaft,
the middle phalange power transmission assembly comprises: a middle phalange drive motor fixedly coupled to the motor fixing base and comprising a second output shaft, and
wherein an axis of the second output shaft is parallel to an axis of the first output shaft.

4. The finger module of claim 3, wherein the proximal phalange power output portion comprises a first ball screw comprising:
a first bearing having an outer race fixedly coupled to the base via a bearing pressure plate;
a first screw fixedly coupled to an inner race of the first bearing and coupled to the first output shaft via a first coupling in the axial direction of the first output shaft, to rotate about an axis of the first screw; and
a first nut movably coupled to the first screw.

5. The finger module of claim 4, wherein the middle phalange power output portion comprises a second ball screw comprising:
a second bearing having an outer race fixedly coupled to the base via the bearing pressure plate;
a second screw fixedly coupled to an inner race of the second bearing and coupled to the second output shaft via a second coupling in the axial direction of the second output shaft, to rotate about an axis of the second screw; and
a second nut movably coupled to the second screw.

6. The finger module of claim 5, wherein the proximal phalange link assembly comprises:
a first proximal phalange connecting block fixedly coupled to the first nut;
a second proximal phalange link having a first end movably coupled to the first proximal phalange connecting block; and
a third proximal phalange link having a first end movably coupled to a second end of the second proximal phalange link via the first pin, a second end of the third proximal phalange link being movably coupled to the proximal phalange link fixing base, and a third end and a fourth end of the third proximal phalange link being movably coupled to the middle phalange link assembly, the first end and the second end being arranged on a side of the third proximal phalange link close to the proximal phalange link fixing base, and the third end and the fourth end being arranged on a side of the third proximal phalange link close to the fingertip link.

7. The finger module of claim 6, wherein the middle phalange link assembly comprises:
a first middle phalange link having a first end movably coupled to the second nut;
a second middle phalange link having a first end movably coupled to a second end of the first middle phalange link;
a third middle phalange link having a first end movably coupled to the second proximal phalange link via the first pin and a second end movably coupled to a second end of the second middle phalange link via a second pin, the third middle phalange link having a triangular cross section in a plane perpendicular to an axis of the first pin, and the first end, the second end, and a third end of the third middle phalange link being three vertices of the triangle;
a fourth middle phalange link having a first end movably coupled to the third end of the third middle phalange link via a third pin;
a fifth middle phalange link having a first end movably coupled to a second end of the fourth middle phalange link, a second end of the fifth middle phalange link being movably coupled to the fingertip link, and a third end of the fifth middle phalange link being movably coupled to the third end of the third proximal phalange link; and
a sixth middle phalange link having a first end movably coupled to the fourth end of the third proximal phalange link and a second end movably coupled to the fingertip link.

8. The finger module of claim 7, wherein the first proximal phalange connecting block comprises:
a first body portion comprising a pair of through holes and a fixing hole located between the pair of through holes, wherein the first nut is fixedly coupled to the fixing hole; and
a first connecting portion arranged to extend from the first body portion in an axial direction of the first screw and having a pair of first connecting holes.

9. The finger module of claim 8, further comprising a pair of guide posts, each guide post of the pair of guide posts passing through a corresponding through hole of the pair of through holes and being symmetrically arranged on two sides of the first screw and fixedly coupled to the base, to be adapted to allow the first proximal phalange connecting block to slide along the guide post.

10. The finger module of claim 8, wherein the second proximal phalange link is generally Y-shaped, and comprises:
a link coupled between a pair of first connecting holes of the first connecting portion of the first proximal phalange connecting block; and
a pair of bifurcated portions arranged at one end of the link and extending in an extending direction of the link, the pair of bifurcated portions having a pair of second connecting holes in a direction perpendicular to the link.

11. The finger module of claim 10, wherein the third proximal phalange link comprises:
a pair of connecting rods;
a U-shaped connecting portion arranged on the pair of connecting rods and extending in a direction perpendicular to the connecting rods;
a pair of first extending portions arranged at an end of the pair of connecting rods close to the proximal phalange link fixing base and movably coupled to the proximal phalange link fixing base;
a pair of lugs arranged on a side of the pair of connecting rods facing the second proximal phalange link and coupled between the pair of second connecting holes of the pair of bifurcated portions via the first pin; and
a pair of second extending portions arranged at an end of the pair of connecting rods away from the proximal phalange link fixing base and movably coupled to the fifth middle phalange link and movably coupled to the sixth middle phalange link.

12. The finger module of claim 11, wherein the third middle phalange link comprises:
a connecting sleeve movably coupled between the pair of lugs of the third proximal phalange link via the first pin; and
a pair of connecting portions extending from the connecting sleeve in a direction perpendicular to an axis of the connecting sleeve and having a triangular shape, one end of a base end of each connecting portion being coupled to the first end of the fourth middle phalange link, and the other end of the base end of each connecting portion being coupled to a second end of the second middle phalange link opposite to the first end.

13. The finger module of claim 7, further comprising a guide rail comprising: a slide rail fixedly coupled to the proximal phalange link fixing base; and
a slider fixedly coupled to the second nut and adapted to perform linear motion along the slide rail.

14. The finger module of claim 1, further comprising an anti-slip rubber sleeve fixedly coupled to the fingertip link.

15. A bionic hand for a robot, comprising:
a palm module movably coupled to a forearm mechanism of the robot via a wrist joint; and
a finger module coupled to the palm module, wherein the finger module comprises:
a base rotatably coupled to a palm module of the robot;
a proximal phalange power transmission assembly and a middle phalange power transmission assembly at least partially fixedly coupled to the base and respectively comprising a proximal phalange power output portion and a middle phalange power output portion capable of performing a telescopic motion in an axial direction of the base;
a proximal phalange link assembly and a middle phalange link assembly, the proximal phalange link assembly being movably coupled between the proximal phalange power output portion and the base, the middle phalange link assembly being movably coupled between the middle phalange power output portion and a fingertip link and being movably coupled to the proximal phalange link assembly; and
the fingertip link movably coupled to a first end of the middle phalange link assembly to be adapted to contact or grasp an object,
wherein the proximal phalange link assembly and the middle phalange link assembly have a common first pin about which the proximal phalange link assembly and the middle phalange link assembly are rotatable, such that shapes of the proximal phalange link assembly and the middle phalange link assembly and a grasping angle of the corresponding fingertip link are changeable under driving of the proximal phalange power output portion and the middle phalange power output portion that perform the telescopic motion.

16. The bionic hand of claim 15, wherein the finger module further comprises:
a motor fixing base fixedly coupled to a side of the base away from the proximal phalange link assembly; and
a proximal phalange link fixing base fixedly coupled to a side of the base close to the proximal phalange link assembly for a first end of the proximal phalange link assembly to be movably coupled.

17. The bionic hand of claim 16, wherein
the proximal phalange power transmission assembly comprises: a proximal phalange drive motor fixedly coupled to the motor fixing base and comprising a first output shaft,
the middle phalange power transmission assembly comprises: a middle phalange drive motor fixedly coupled to the motor fixing base and comprising a second output shaft, and
wherein an axis of the second output shaft is parallel to an axis of the first output shaft.

18. The bionic hand of claim 17, wherein the proximal phalange power output portion comprises a first ball screw comprising:
a first bearing having an outer race fixedly coupled to the base via a bearing pressure plate;
a first screw fixedly coupled to an inner race of the first bearing and coupled to the first output shaft via a first coupling in the axial direction of the first output shaft, to rotate about an axis of the first screw; and
a first nut movably coupled to the first screw.

19. The bionic hand of claim 18, wherein the middle phalange power output portion comprises a second ball screw comprising:
a second bearing having an outer race fixedly coupled to the base via the bearing pressure plate;
a second screw fixedly coupled to an inner race of the second bearing and coupled to the second output shaft via a second coupling in the axial direction of the second output shaft, to rotate about an axis of the second screw; and
a second nut movably coupled to the second screw.

20. The bionic hand of claim 19, wherein the proximal phalange link assembly comprises:
a first proximal phalange connecting block fixedly coupled to the first nut;
a second proximal phalange link having a first end movably coupled to the first proximal phalange connecting block; and
a third proximal phalange link having a first end movably coupled to a second end of the second proximal phalange link via the first pin, a second end of the third proximal phalange link being movably coupled to the proximal phalange link fixing base, and a third end and a fourth end of the third proximal phalange link being movably coupled to the middle phalange link assembly, the first end and the second end being arranged on a side of the third proximal phalange link close to the proximal phalange link fixing base, and the third end and the fourth end being arranged on a side of the third proximal phalange link close to the fingertip link.
